(19) United States
(12) Patent Application Publication
(10) Pub. No.: US 2026/0010448 A1
(43) Pub. Date: Jan. 8, 2026

(54) SYSTEM AND METHOD FOR ANOMALY DETECTION

(71) Applicant: Samsung Display Co., Ltd., Yongin-si (KR)

(72) Inventors: Qisen CHENG, Sunnyvale, CA (US); Kaushik BALAKRISHNAN, Fremont, CA (US); Zhihong PAN, San Jose, CA (US); Shuhui QU, Fremont, CA (US); Janghwan LEE, Pleasanton, CA (US)

(21) Appl. No.: 18/927,844

(22) Filed: Oct. 25, 2024

Related U.S. Application Data
(60) Provisional application No. 63/668,742, filed on Jul. 8, 2024.

(51) Int. Cl. G06F 11/22

(52) U.S. Cl. CPC G06F 11/2263

(57) ABSTRACT

A system and a method are disclosed for anomaly detection. In some embodiments, a method includes: converting a plurality of received time-domain signals to a plurality of latent vectors with an encoder neural network; converting the plurality of latent vectors to random vectors with a temporal neural network and sampling operation; converting the plurality of latent vectors to a connectivity representation with a spatial neural network; merging the latent vectors and the connectivity representation; and transmitting a determination of whether the received time-domain signals are normal, based on the latent vectors and the connectivity representation.

### CROSS-REFERENCE TO RELATED APPLICATION

This application claims the priority benefit under 35 U.S.C. § 119 (e) of U.S. Provisional Application No. 63/668,742, filed on Jul. 8, 2024, the disclosure of which is incorporated by reference in its entirety as if fully set forth herein.

### TECHNICAL FIELD

The disclosure generally relates to signal analysis. More particularly, the subject matter disclosed herein relates to improvements to a system and method for anomaly detection.

### SUMMARY

Monitoring equipment may be used in various circumstances, such as in manufacturing facilities. In such an application, monitoring equipment may be used to collect signals that may include indications of malfunctions such as malfunctioning robots. Analyzing such signals to detect actual or incipient malfunctions may be challenging, however

To solve this problem, a machine learning system may be employed to detect, in the signals, indications of malfunctioning equipment.

One issue with the above approach is that if malfunctions are rare, then examples of signals corresponding to abnormal behavior (e.g., to malfunctioning equipment) may be rare, and it may therefore be challenging to perform supervised training with labeled data set, each signal in the data set being labeled, for example, as normal or abnormal. Another issue with the above approach is that indications of abnormal behavior may be present in the temporal characteristics of the signals (e.g., in a variation with time of one or more signals) or in spatial characteristics of the signals (e.g., in the manner in which signals obtained from different sensors vary relative to each other).

To overcome these issues, systems and methods are described herein for identifying abnormal signals, based on both the temporal and the spatial characteristics of the signals. The systems and methods may further include a machine learning classifier trained, with a collection of normal data, to reconstruct the data; the classifier may then perform poorly in reconstructing abnormal data, and such deficient reconstruction (which may be detected as an unusually large value of a measure of discrepancy between the received signal and the reconstructed signal) may be used as an indicator of an abnormal signal.

The above approach improves on previous methods because it takes into account both the temporal and the spatial characteristics of the signals, and because it does not require examples of abnormal signals for training. As such, systems and methods disclosed herein improve on the technology of abnormal signal detection, and on the technology of detecting malfunctions, or incipient malfunctions, in robots used in manufacturing facilities.

According to an embodiment of the present disclosure, there is provided a method, including: converting a plurality of received time-domain signals to a plurality of latent vectors with an encoder neural network; converting the plurality of latent vectors to random vectors with a temporal neural network and sampling operation; converting the plurality of latent vectors to a connectivity representation with a spatial neural network; merging the latent vectors and the connectivity representation; and transmitting a determination of whether the received time-domain signals are normal, based on the latent vectors and the connectivity representation.

In some embodiments, the merging of the latent vectors and the connectivity representation includes merging the latent vectors and the connectivity representation into a graph.

In some embodiments, the method further includes aggregating nodes of the graph with a graph aggregation neural network to form a plurality of aggregated temporal representations.

In some embodiments: a first node of the graph is a first latent vector, a second node of the graph is a second latent vector, and an edge of the graph is a dependency relation between the first latent vector and the second latent vector.

In some embodiments, the method further includes converting the aggregated temporal representations to reconstructed time-domain signals using a decoder neural network.

In some embodiments, the method further includes determining whether the received time-domain signals are normal based on a measure of discrepancy between the received time-domain signals and the reconstructed time-domain signals.

In some embodiments, the measure of discrepancy is an L2 norm.

In some embodiments, the encoder neural network includes a plurality of Structured State Space for Sequence Modeling (S4) neural networks.

In some embodiments, the temporal neural network and sampling operation includes generating a pseudorandom number based on a Gaussian distribution and based on a mean and a variance generated by the temporal neural network.

In some embodiments, the temporal neural network includes a first neural network and a second neural network, each configured to receive all of the time domain signals, and a third neural network configured to receive all of the time domain signals except a most recent sample.

In some embodiments, the method further includes training with a training data set, wherein the training data set includes only normal signals.

In some embodiments, the method further includes training with a loss function including a measure of discrepancy between the received time-domain signals and reconstructed time-domain signals.

In some embodiments, the loss function further includes a measure of discrepancy between: a conditional probability density function for a set of latent vectors conditioned on a set of received time-domain signals, and a conditional probability density function for temporal transitions in the sets of latent vectors.

According to an embodiment of the present disclosure, there is provided a system, including: a processing circuit; and a memory, connected to the processing circuit, the memory storing instructions that, when executed by the processing circuit, cause the processing circuit to perform a method, the method including: converting a plurality of received time-domain signals to a plurality of latent vectors with an encoder neural network; converting the plurality of latent vectors to random vectors with a temporal neural network and sampling operation; converting the plurality of latent vectors to a connectivity representation with a spatial neural network; merging the latent vectors and the connectivity representation; and transmitting a determination of whether the received time-domain signals are normal, based on the latent vectors and the connectivity representation.

In some embodiments, the merging of the latent vectors and the connectivity representation includes merging the latent vectors and the connectivity representation into a graph.

In some embodiments, the method further includes aggregating nodes of the graph with a graph aggregation neural network to form a plurality of aggregated temporal representations.

In some embodiments: a first node of the graph is a first latent vector, a second node of the graph is a second latent vector, and an edge of the graph is a dependency relation between the first latent vector and the second latent vector.

In some embodiments, the method further includes converting the aggregated temporal representations to reconstructed time-domain signals using a decoder neural network.

In some embodiments, the method further includes determining whether the received time-domain signals are normal based on a measure of discrepancy between the received time-domain signals and the reconstructed time-domain signals.

According to an embodiment of the present disclosure, there is provided a computer-readable medium storing instructions that, when executed by a processing circuit, cause the processing circuit to perform a method, the method including: converting a plurality of received time-domain signals to a plurality of latent vectors with an encoder neural network; converting the plurality of latent vectors to random vectors with a temporal neural network and sampling operation; converting the plurality of latent vectors to a connectivity representation with a spatial neural network; merging the latent vectors and the connectivity representation; and transmitting a determination of whether the received time-domain signals are normal, based on the latent vectors and the connectivity representation.

### BRIEF DESCRIPTION OF THE DRAWINGS

In the following section, the aspects of the subject matter disclosed herein will be described with reference to exemplary embodiments illustrated in the figures, in which:

FIG. 1 is a system diagram, showing a system being monitored and a classifier for monitoring and analyzing signals from the system being monitored, according to an embodiment.

FIG. 2A is a block diagram of a classifier, according to an embodiment.

FIG. 2B is a block diagram of a temporal neural network and sampling operation, according to an embodiment.

FIG. 2C is a block diagram of a spatial neural network and sampling operation, according to an embodiment.

FIG. 2D is a block diagram of a merging network and of a decoder, according to an embodiment.

FIG. 3A is a flow chart of a first portion of a method, according to an embodiment.

FIG. 3B is a flow chart of a second portion of a method, according to an embodiment.

FIG. 4 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

Robots may be employed in modern manufacturing lines of semiconductor devices or electronic devices, such as display panels, to achieve efficient and mass-scale production. Unexpected failures may occur in robots during heavy daily operations. Such failures may cause a waste of production time, materials and energy, and lead to extra time and costs for urgent repairs and recovery, thus significantly impairing manufacturing efficiency.

Preventive maintenance of robots has been demonstrated to be important in prevention of unexpected failures. Through regular inspections, less severe malfunctions may be found and corrected at an early stage, avoiding eventual costly failures. Conventional preventive maintenance, however, requires laborious manual monitoring of robot health.

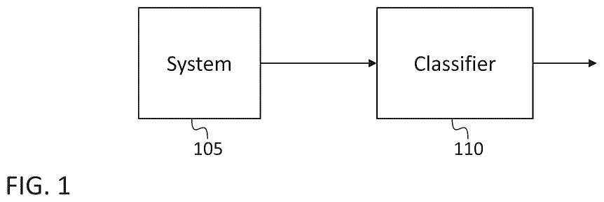

In some embodiments, monitoring of robot health may be automated by using machine learning techniques to detect early malfunction signals by processing sensor timeseries data from sensors installed on or around the robots. FIG. 1 shows such a configuration, including a system 105 being monitored (e.g., a manufacturing system including one or more robots equipped with sensors) and a classifier 110, which receives one or more signals (e.g., from respective sensors) and classifies the set of signals as normal or abnormal. Each of the signals may be a time series of samples, (e.g., data samples received from a sensor), each of the samples having been obtained at a corresponding point in time, or “time point”. As used herein, a signal or set of signals may be referred to as (i) “abnormal” if it indicates that the system from which it originates is malfunctioning or shows symptoms of an incipient malfunction and (ii) “normal” otherwise.

It may be challenging to train a machine learning model to detect early malfunctions of a robot from sensor readings. One challenge in constructing such a system is that timeseries anomalies may include diverse and subtle patterns in a time interval preceding malfunction of a robot, which may be referred to as the early deterioration stage. For example, a manufacturing robot may be equipped with multiple sensors, and anomalies may be present in a single sensor signal, or anomalies may appear in irregular correlations between different sensor readouts, or may be found in deviations of all sensor signals.

Furthermore, anomaly patterns in the early deterioration stage may be relatively subtle and unobvious; this may make distinguishing signals containing such anomaly patterns from normal signals challenging. For example, in a monitoring system with multiple sensor signals, the relation between signals may signal an anomaly. Anomaly patterns may be subtle, and may include, for example, transient anomalies, e.g., signals in which only few time points are abnormal (e.g., contain unusual peaks) or signals with localized anomalies, such as non-repeating deviations (e.g. waveform changes). The effects of anomalies may be small, and the magnitude of the irregularity in an abnormal signal may be relatively small, e.g., compared to the normal magnitude of the signal or compared to noise in the signal.

A second challenge is the scarcity of abnormal samples, because the normal and abnormal data populations may be highly imbalanced. As such, the training of the detection model (e.g., a binary classifier) using sufficient normal and abnormal labeled data may not be feasible.

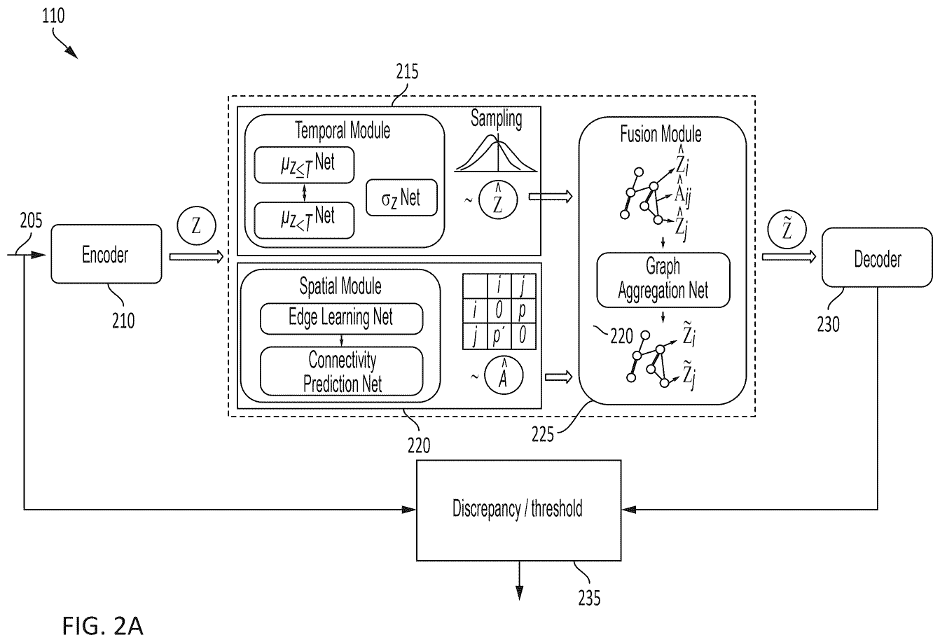

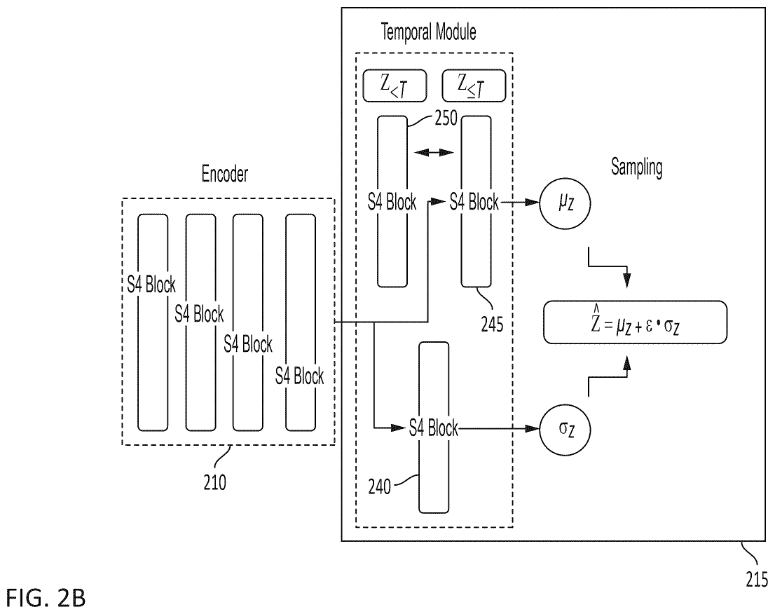

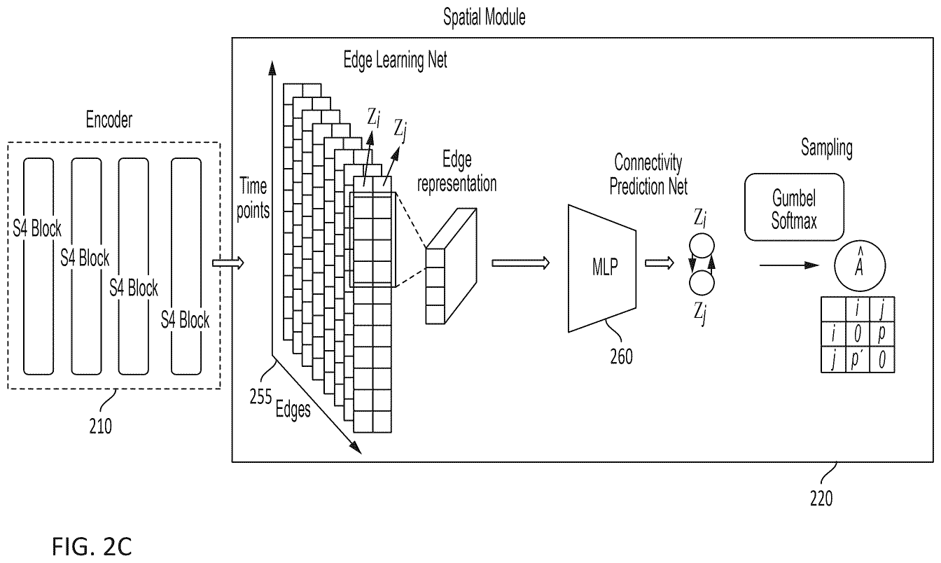

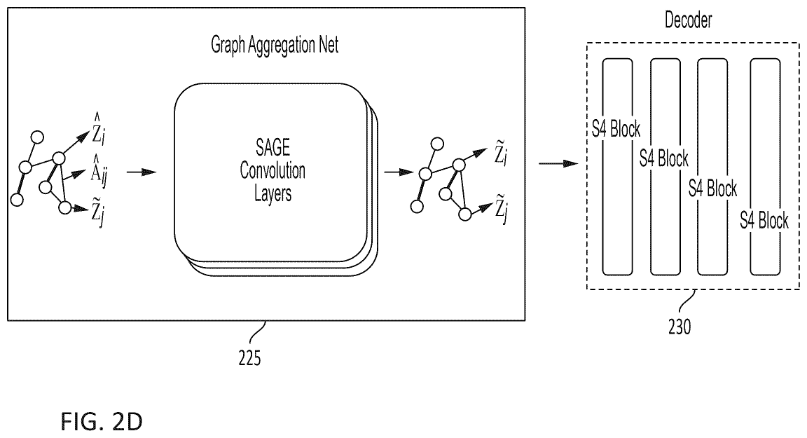

As such, in some embodiments, training is performed using only normal data, as discussed in further detail below. FIG. 2A is a top-level block diagram of a classifier 110 which is a machine-learning model that may be employed to classify received sensor signals as normal or abnormal. Time-domain signals (e.g., signals from sensors with which manufacturing robots are equipped) are received at an input 205, and encoded by an encoder 210, to form a set of latent vectors Z for each time point of the time-domain signals. The latent vectors are fed into (i) a temporal neural network and sampling operation 215 and (ii) a spatial neural network and sampling operation 220. The outputs of the temporal neural network and sampling operation 215 and those of the spatial neural network and sampling operation 220 are fed to a merging network 225, which generates reconstructed latent vectors, that are fed to a decoder 230, which converts the reconstructed latent vectors to reconstructed time-domain signals. The classifier 110 may be trained (as discussed in further detail below) to be capable of reconstructing normal sensor signals; as such, the discrepancy between the received time-domain signals and the reconstructed time-domain signals may be small if the received time-domain signals are normal signals. As such, a discrepancy and threshold circuit 235 may be employed to (i) calculate a measure of discrepancy between the received time-domain signals and the reconstructed time-domain signals and (ii) determine (e.g., by comparing the measure of discrepancy to a threshold) whether the measure of discrepancy indicates that the time domain signals are normal or abnormal. The measure of discrepancy may be any suitable mapping from the difference between two sets of signals to a number. For example, the measure of discrepancy may be the L2 norm (which may also be referred to as the Euclidean norm) of the difference between the received time-domain signals and the reconstructed time-domain signals. In other embodiments any other norm may be employed instead of the L2 norm, e.g., any p-norm (the 2-norm being the same as the L2 norm) with a value of p different from 2 may be used. This measure of discrepancy may also be used as a first loss function, for training (as discussed in further detail below).

FIG. 2B is a block diagram of the temporal neural network and sampling operation 215. The temporal neural network and sampling operation 215 may be used to learn the temporal dynamics of the latent vectors, e.g., the transitions between latent representations of time points, and to generate a set of latent vectors having a Gaussian distribution with a specified mean and variance. Each of (i) the encoder 210 and (ii) the temporal neural network and sampling operation 215 includes a number of Structured State Space for Sequence Modeling (S4) neural networks, as shown. A plurality of Structured State Space for Sequence Modeling (S4) neural networks (each of which is labeled “S4” in FIG. 2B) may be used to construct the encoder 210. Further, the temporal neural network and sampling operation 215 may include a first neural network 240 and a second neural network 245, each of which is configured to receive the entire time series of latent vectors, and a third neural network 250, configured to receive all of the time domain signals except the most recent sample. Based on the second neural network 245 and the third neural network 250, a mean value for transitions, in the set of latent vectors, between consecutive time points, may be calculated (this mean value may be referred to as μ_{z}), and based on the first neural network 240, a variance may be calculated.

The mean and the variance may then be sampled, e.g., a Gaussian pseudorandom vector may be generated, at each time step, with the mean and variance generated by the first neural network 240, the second neural network 245, and the third neural network 250. As shown in FIG. 2B, this may be accomplished by multiplying a zero-mean unit variance Gaussian pseudorandom vector & by the variance generated by the first neural network 240, and adding the mean uz generated by the first neural network 240 and the second neural network 245. The third neural network 250 may have an identical architecture to the second neural network 245. The second neural network 245 takes in a sequence of vectors each of which corresponds to one time point of the input signal, whereas the network 250 takes in the same sequence but delayed by one time point; where the last vector is omitted and a dummy vector is prepended at the start. The second neural network 245, and the third neural network 250 may be trained to output similar mean vectors to model the transitions between time points.

The temporal module (which, as shown in FIG. 2B, includes the first neural network 240, the second neural network 245, and the third neural network 250) may model the temporal transitions as a conditional multivariate Gaussian distribution p_{λ}(zₜ|z_{<t}) i.e.,

$${p}_{λ} ( {z}_{t} \vert {z}_{< t} ) = ( {μ}_{z} ( {z}_{< t} ) , {σ}_{z} ( {z}_{< t} ) )$$

The conditional probability density function of the latent vectors given the received time-domain signals x may be written as follows:

$${p}_{φ} ( {z}_{\leq T} \vert {x}_{\leq T} ) = {\prod }_{t = 0}^{T} {p}_{φ} ( {z}_{t} \vert {x}_{\leq t} )$$

A second loss function used for training may then be defined as a measure of discrepancy between (i) the conditional probability density function (p_{φ}(z_{≤T}|x_{≤T})) for the set of latent vectors Z conditioned on the set of received time-domain signals x and (ii) the conditional probability density function (p_{λ}(zₜ|z_{<t})) that models the temporal transitions in the sets of latent vectors. This second component of the loss function may use, for example, the Kullback-Leibler divergence D_{KL}, so that the second loss function is

$${D}_{KL} ( {p}_{φ} ( {z}_{t} \vert {x}_{\leq t} ) ‖ {p}_{λ} ( {z}_{t} \vert {z}_{< t} ) ) .$$

FIG. 2C is a block diagram of the spatial neural network and sampling operation 220. The spatial neural network and sampling operation 220 may be employed to learn the spatial relation between each pair of variables (e.g. sensors) in the received time-domain signals (e.g., in the measurements from sensors with which manufacturing robots may be equipped). The spatial neural network and sampling operation 220 models the relations as a directed graph with bidirectional connectivity. Each node of the graph corresponds to an element of the latent vector Z, and each edge of the graph includes two weights to reflect asymmetric dependency relations between the elements of the latent vectors. Each directed edge is modeled as a Bernoulli distribution with parameter p; the two values of p may be the off-diagonal elements of a 2×2 matrix Â, as shown at the right of FIG. 2C. An edge learning net 255 (which may be a one-dimensional convolutional neural network (1D-CNN)) may learn a condensed representation from each pair of involved nodes, and a connectivity prediction net 260 (which may be a multilayer perceptron (MLP)) may predict the parameter p for each directed edge. The output of the spatial neural network and sampling operation 220 may be a connectivity representation including a plurality of pairs of edge weights (e.g., two weights shown as off-diagonal elements of the 2×2 matrix Â in FIG. 2C).

FIG. 2D is a block diagram of the merging network 225 and the decoder 230. To enforce the effective learning of both the temporal and spatial information, the two paths (the path through the temporal neural network and sampling operation 215 and the path through the spatial neural network and sampling operation 220) may be fused through a graph aggregation network in the merging network 225. The merging network 225 may include a plurality of SAmple and aggreGatE (SAGE) convolution layers for merging the latent vectors and the connectivity representation. The merging network 225 treats the sampled temporal representations as nodes in a graph and the sampled connectivity matrix as edge weights. The information of the nodes may be aggregated, in the merging network 225, through message passing, a mechanism that aggregates representations of neighboring nodes to each node with consideration of connectivity (edge weights). The aggregated temporal representations may then be fed to the decoder 230 for signal reconstruction.

The classifier 110 may be trained with a single set of data that includes only normal received time-domain signals, using a composite loss function that is, e.g., a weighted sum of the first loss function and the second loss function described above. In some embodiments, the first loss function and the second loss function are weighted equally in the weighted sum.

In some embodiments, a continuous monitoring framework is used to detect actual or incipient malfunction. The continuous monitoring framework may include (i) extraction of operational periods, e.g., extracting only the time periods when a robot is continuously operating, rather than, e.g., stopped for repair, or idle and (ii) sliding-window analysis, which may generate anomaly scores periodically on the signal data from a recent time interval. The anomaly scores may have two parts to capture anomalies with diverse patterns; these parts may be the values of the first loss function and the second loss function, respectively.

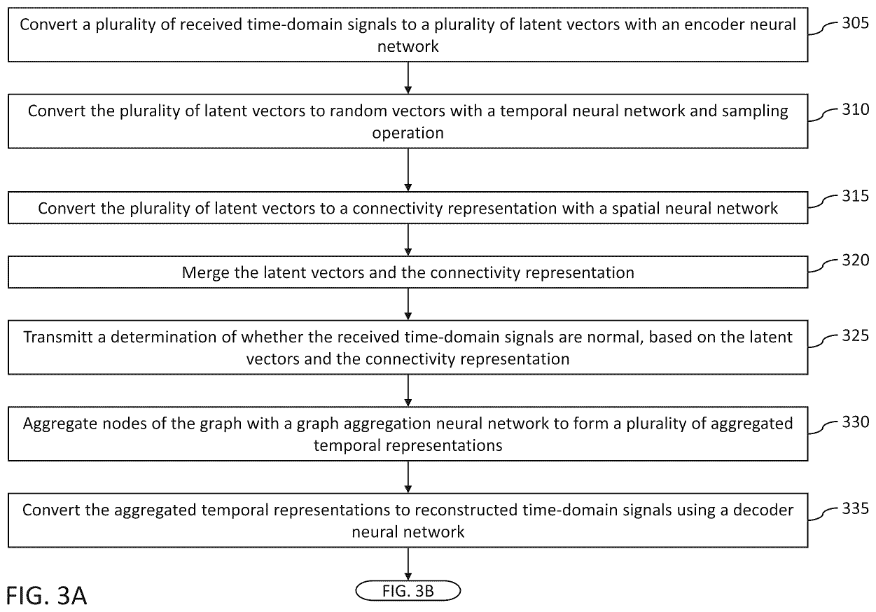

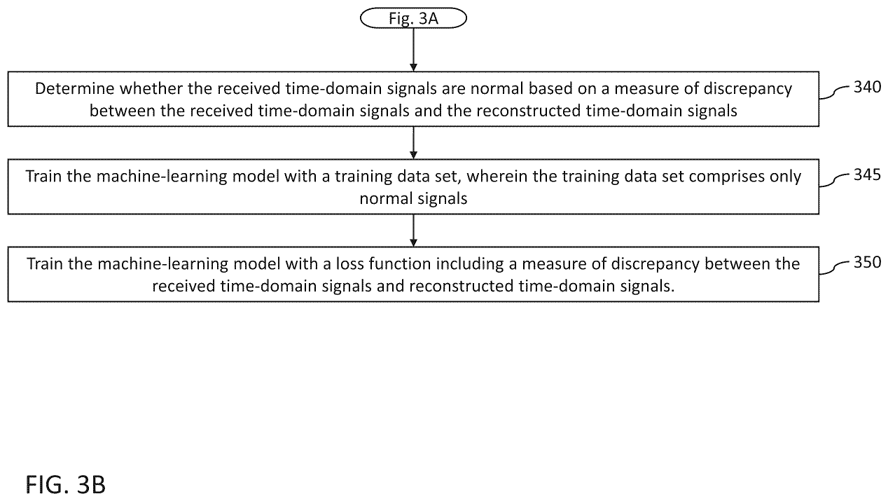

FIGS. 3A and 3B show a method of classifying signals as normal or abnormal, in some embodiments. Although FIGS. 3A and 3B illustrate various operations in such a method, embodiments according to the present disclosure are not limited thereto. For example, according to some embodiments, such a method may include additional operations or fewer operations, or the order of operations may vary (unless otherwise explicitly stated or implied) without departing from the spirit and scope of embodiments according to the present disclosure.

The method includes converting, at 305, a plurality of received time-domain signals to a plurality of latent vectors with an encoder neural network. For example, as discussed above in the context of FIGS. 2A-2C, a plurality of Structured State Space for Sequence Modeling (S4) neural networks may transform the received time-domain signals to sets of latent vectors, one set of latent vectors corresponding to each time point for which the received time-domain signals include samples. The method further includes converting, at 310, the plurality of latent vectors to random vectors with a temporal neural network and sampling operation. For example, as discussed above in the context of FIGS. 2A-2C, the temporal neural network and sampling operation 215 may extract mean and variance information regarding the transition (from one time point to the next time point) in the latent vectors, and then generate, at each time step, a set of pseudorandom latent vectors having, as their transition probability density function, a Gaussian function based on the extracted mean and variance information. In some embodiments, as mentioned above, the temporal neural network and sampling operation 215 comprises a first neural network 240 and a second neural network 245, each configured to receive all of the time domain signals, and a third neural network 250 configured to receive all of the time domain signals except a most recent sample.

The method further includes converting, at 315, the plurality of latent vectors to a connectivity representation with a spatial neural network and sampling operation. For example, as discussed above in the context of FIGS. 2A-2C the plurality of latent vectors may be converted to an edge representation by an edge learning network (or “edge learning net”) and then converted, by a multilayer perceptron (MLP) to the connectivity representation. The method further includes merging, at 320, the latent vectors and the connectivity representation. For example, as discussed above in the context of FIGS. 2A and 2D, a graph aggregation network may be used to merge the latent vectors and the connectivity representation, to generate a set of reconstructed latent vectors.

The method further includes transmitting, at 325, a determination of whether the received time-domain signals are normal, based on the latent vectors and the connectivity representation. The transmitting may include, for example, (i) sending an indication of the determination (e.g., a message indicating whether the received time-domain signals are normal or abnormal) to another circuit (which may automatically take remedial action, such as halting a production flow before a malfunctioning robot damages work in process) or (ii) sending or displaying an alert (e.g., a warning tone or a warning message) to a user, using, e.g., a loudspeaker or a video display. The determination may be made based on the values of the first and second loss functions after reconstructing time-domain signals, by the decoder 230, from the reconstructed latent vectors (as discussed in further detail below). The merging of the latent vectors and the connectivity representation may include merging the latent vectors and the connectivity representation into a graph. The method further includes aggregating, at 330, nodes of the graph with a graph aggregation neural network to form a plurality of aggregated temporal representations. For example, in as discussed above the context of FIG. 2D, the aggregating may be performed by the graph aggregation neural network 225.

In some embodiments, a first node of the graph is a first latent vector, a second node of the graph is a second latent vector, and an edge of the graph is a dependency relation between the first latent vector and the second latent vector. The method further includes, as mentioned above, converting, at 335, the aggregated temporal representations to reconstructed time-domain signals using a decoder neural network. The method further includes determining, at 340, whether the received time-domain signals are normal based on a measure of discrepancy between the received time-domain signals and the reconstructed time-domain signals. The measure of discrepancy may be, for example, the first loss function, or the second loss function, or a weighted sum of the first loss function and the second loss function. In some embodiments, the measure of discrepancy is an L2 norm. Steps 305-340 may be performed as part of an inference operation of the classifier 110. These steps may also be performed during training.

The method further includes training the machine-learning model, at 345, with a training data set, wherein the training data set comprises only normal signals. The method further includes training the machine-learning model, at 350, with a loss function including a measure of discrepancy between the received time-domain signals and reconstructed time-domain signals. In some embodiments, the loss function further includes the second loss function, e.g., it includes a measure of discrepancy between (i) a conditional probability density function for a set of latent vectors conditioned on a set of received time-domain signals, and (ii) a conditional probability density function for temporal transitions in the sets of latent vectors.

Although some examples herein are explained in the context of detecting abnormal signals from sensors on robots in a manufacturing facility, this disclosure is not limited to such applications, and the systems and methods disclosed herein may be used for analyzing signals in a broad variety of contexts. For example, medical signals (such as electrocardiogram signals) may be analyzed, to determine whether they are normal or abnormal, using analogous systems and methods.

The systems and methods disclosed herein may improve the capability of systems to detect abnormal signals and the corresponding abnormal states, and, as such, the systems and methods disclosed herein may involve improvements to the technologies of monitoring manufacturing processes, or monitoring processes in general.

Each of the terms “processing circuit” and “means for processing” is used herein to mean any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example, a processing circuit may include two processing circuits, an FPGA and a CPU, interconnected on a PCB.

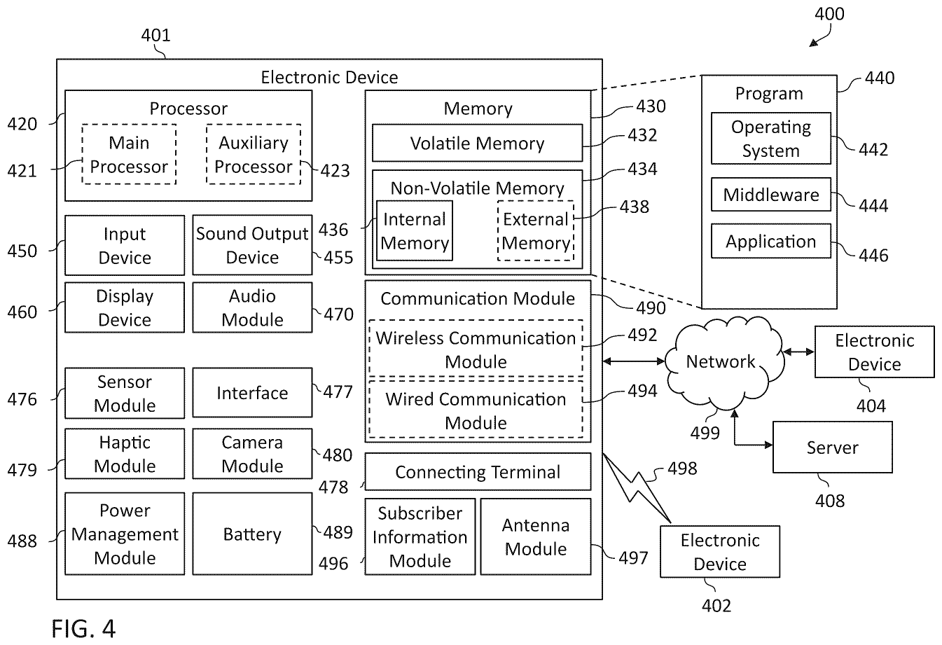

FIG. 4 is a block diagram of an electronic device in a network environment 400, according to an embodiment. Such an electronic device may be connected to receive monitoring signals (e.g., from sensors on robots in a manufacturing facility), and it may incorporate a classifier 110 according to embodiments described herein.

Referring to FIG. 4, an electronic device 401 in a network environment 400 may communicate with an electronic device 402 via a first network 498 (e.g., a short-range wireless communication network), or an electronic device 404 or a server 408 via a second network 499 (e.g., a long-range wireless communication network). The electronic device 401 may communicate with the electronic device 404 via the server 408. The electronic device 401 may include a processor 420, a memory 430, an input device 450, a sound output device 455, a display device 460, an audio module 470, a sensor module 476, an interface 477, a haptic module 479, a camera module 480, a power management module 488, a battery 489, a communication module 490, a subscriber identification module (SIM) card 496, or an antenna module 497. In one embodiment, at least one (e.g., the display device 460 or the camera module 480) of the components may be omitted from the electronic device 401, or one or more other components may be added to the electronic device 401. Some of the components may be implemented as a single integrated circuit (IC). For example, the sensor module 476 (e.g., a fingerprint sensor, an iris sensor, or an illuminance sensor) may be embedded in the display device 460 (e.g., a display).

The processor 420 may execute software (e.g., a program 440) to control at least one other component (e.g., a hardware or a software component) of the electronic device 401 coupled with the processor 420 and may perform various data processing or computations.

As at least part of the data processing or computations, the processor 420 may load a command or data received from another component (e.g., the sensor module 476 or the communication module 490) in volatile memory 432, process the command or the data stored in the volatile memory 432, and store resulting data in non-volatile memory 434. The processor 420 may include a main processor 421 (e.g., a central processing unit (CPU) or an application processor (AP)), and an auxiliary processor 423 (e.g., a graphics processing unit (GPU), an image signal processor (ISP), a sensor hub processor, or a communication processor (CP)) that is operable independently from, or in conjunction with, the main processor 421. Additionally or alternatively, the auxiliary processor 423 may be adapted to consume less power than the main processor 421, or execute a particular function. The auxiliary processor 423 may be implemented as being separate from, or a part of, the main processor 421.

The auxiliary processor 423 may control at least some of the functions or states related to at least one component (e.g., the display device 460, the sensor module 476, or the communication module 490) among the components of the electronic device 401, instead of the main processor 421 while the main processor 421 is in an inactive (e.g., sleep) state, or together with the main processor 421 while the main processor 421 is in an active state (e.g., executing an application). The auxiliary processor 423 (e.g., an image signal processor or a communication processor) may be implemented as part of another component (e.g., the camera module 480 or the communication module 490) functionally related to the auxiliary processor 423.

The memory 430 may store various data used by at least one component (e.g., the processor 420 or the sensor module 476) of the electronic device 401. The various data may include, for example, software (e.g., the program 440) and input data or output data for a command related thereto. The memory 430 may include the volatile memory 432 or the non-volatile memory 434. Non-volatile memory 434 may include internal memory 436 and/or external memory 438.

The program 440 may be stored in the memory 430 as software, and may include, for example, an operating system (OS) 442, middleware 444, or an application 446.

The input device 450 may receive a command or data to be used by another component (e.g., the processor 420) of the electronic device 401, from the outside (e.g., a user) of the electronic device 401. The input device 450 may include, for example, a microphone, a mouse, or a keyboard.

The sound output device 455 may output sound signals to the outside of the electronic device 401. The sound output device 455 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 460 may visually provide information to the outside (e.g., a user) of the electronic device 401. The display device 460 may include, for example, a display, a hologram device, or a projector and control circuitry to control a corresponding one of the display, hologram device, and projector. The display device 460 may include touch circuitry adapted to detect a touch, or sensor circuitry (e.g., a pressure sensor) adapted to measure the intensity of force incurred by the touch.

The audio module 470 may convert a sound into an electrical signal and vice versa. The audio module 470 may obtain the sound via the input device 450 or output the sound via the sound output device 455 or a headphone of an external electronic device 402 directly (e.g., wired) or wirelessly coupled with the electronic device 401.

The sensor module 476 may detect an operational state (e.g., power or temperature) of the electronic device 401 or an environmental state (e.g., a state of a user) external to the electronic device 401, and then generate an electrical signal or data value corresponding to the detected state. The sensor module 476 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 477 may support one or more specified protocols to be used for the electronic device 401 to be coupled with the external electronic device 402 directly (e.g., wired) or wirelessly. The interface 477 may include, for example, a high-definition multimedia interface (HDMI), a universal serial bus (USB) interface, a secure digital (SD) card interface, or an audio interface.

A connecting terminal 478 may include a connector via which the electronic device 401 may be physically connected with the external electronic device 402. The connecting terminal 478 may include, for example, an HDMI connector, a USB connector, an SD card connector, or an audio connector (e.g., a headphone connector).

The haptic module 479 may convert an electrical signal into a mechanical stimulus (e.g., a vibration or a movement) or an electrical stimulus which may be recognized by a user via tactile sensation or kinesthetic sensation. The haptic module 479 may include, for example, a motor, a piezoelectric element, or an electrical stimulator.

The camera module 480 may capture a still image or moving images. The camera module 480 may include one or more lenses, image sensors, image signal processors, or flashes. The power management module 488 may manage power supplied to the electronic device 401. The power management module 488 may be implemented as at least part of, for example, a power management integrated circuit (PMIC).

The battery 489 may supply power to at least one component of the electronic device 401. The battery 489 may include, for example, a primary cell which is not rechargeable, a secondary cell which is rechargeable, or a fuel cell.

The communication module 490 may support establishing a direct (e.g., wired) communication channel or a wireless communication channel between the electronic device 401 and the external electronic device (e.g., the electronic device 402, the electronic device 404, or the server 408) and performing communication via the established communication channel. The communication module 490 may include one or more communication processors that are operable independently from the processor 420 (e.g., the AP) and supports a direct (e.g., wired) communication or a wireless communication. The communication module 490 may include a wireless communication module 492 (e.g., a cellular communication module, a short-range wireless communication module, or a global navigation satellite system (GNSS) communication module) or a wired communication module 494 (e.g., a local area network (LAN) communication module or a power line communication (PLC) module). A corresponding one of these communication modules may communicate with the external electronic device via the first network 498 (e.g., a short-range communication network, such as BLUETOOTH™, wireless-fidelity (Wi-Fi) direct, or a standard of the Infrared Data Association (IrDA)) or the second network 499 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 492 may identify and authenticate the electronic device 401 in a communication network, such as the first network 498 or the second network 499, using subscriber information (e.g., international mobile subscriber identity (IMSI)) stored in the subscriber identification module 496.

The antenna module 497 may transmit or receive a signal or power to or from the outside (e.g., the external electronic device) of the electronic device 401. The antenna module 497 may include one or more antennas, and, therefrom, at least one antenna appropriate for a communication scheme used in the communication network, such as the first network 498 or the second network 499, may be selected, for example, by the communication module 490 (e.g., the wireless communication module 492). The signal or the power may then be transmitted or received between the communication module 490 and the external electronic device via the selected at least one antenna.

Commands or data may be transmitted or received between the electronic device 401 and the external electronic device 404 via the server 408 coupled with the second network 499. Each of the electronic devices 402 and 404 may be a device of a same type as, or a different type, from the electronic device 401. All or some of operations to be executed at the electronic device 401 may be executed at one or more of the external electronic devices 402, 404, or 408. For example, if the electronic device 401 should perform a function or a service automatically, or in response to a request from a user or another device, the electronic device 401, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 401. The electronic device 401 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method, comprising:
converting a plurality of received time-domain signals to a plurality of latent vectors with an encoder neural network;
converting the plurality of latent vectors to random vectors with a temporal neural network and sampling operation;
converting the plurality of latent vectors to a connectivity representation with a spatial neural network and sampling operation;
merging the latent vectors and the connectivity representation; and
transmitting a determination of whether the received time-domain signals are normal, based on the latent vectors and the connectivity representation.

2. The method of claim 1, wherein the merging of the latent vectors and the connectivity representation comprises merging the latent vectors and the connectivity representation into a graph.

3. The method of claim 2, further comprising aggregating nodes of the graph with a graph aggregation neural network to form a plurality of aggregated temporal representations.

4. The method of claim 2, wherein:
a first node of the graph is a first latent vector,
a second node of the graph is a second latent vector, and
an edge of the graph is a dependency relation between the first latent vector and the second latent vector.

5. The method of claim 3, further comprising converting the aggregated temporal representations to reconstructed time-domain signals using a decoder neural network.

6. The method of claim 5, further comprising determining whether the received time-domain signals are normal based on a measure of discrepancy between the received time-domain signals and the reconstructed time-domain signals.

7. The method of claim 6, wherein the measure of discrepancy is an L2 norm.

8. The method of claim 1, wherein the encoder neural network comprises a plurality of Structured State Space for Sequence Modeling (S4) neural networks.

9. The method of claim 1, wherein the temporal neural network and sampling operation comprises generating a pseudorandom number based on a Gaussian distribution and based on a mean and a variance generated by the temporal neural network.

10. The method of claim 1, wherein the temporal neural network comprises a first neural network and a second neural network, each configured to receive all of the time domain signals, and a third neural network configured to receive all of the time domain signals except a most recent sample.

11. The method of claim 1, further comprising training with a training data set, wherein the training data set comprises only normal signals.

12. The method of claim 1, further comprising training with a loss function including a measure of discrepancy between the received time-domain signals and reconstructed time-domain signals.

13. The method of claim 12, wherein the loss function further includes a measure of discrepancy between:
a conditional probability density function for a set of latent vectors conditioned on a set of received time-domain signals, and
a conditional probability density function for temporal transitions in the sets of latent vectors.

14. A system, comprising:
a processing circuit; and
a memory, connected to the processing circuit, the memory storing instructions that, when executed by the processing circuit, cause the processing circuit to perform a method, the method comprising:
converting a plurality of received time-domain signals to a plurality of latent vectors with an encoder neural network;
converting the plurality of latent vectors to random vectors with a temporal neural network and sampling operation;
converting the plurality of latent vectors to a connectivity representation with a spatial neural network and sampling operation;
merging the latent vectors and the connectivity representation; and
transmitting a determination of whether the received time-domain signals are normal, based on the latent vectors and the connectivity representation.

15. The system of claim 14, wherein the merging of the latent vectors and the connectivity representation comprises merging the latent vectors and the connectivity representation into a graph.

16. The system of claim 15, wherein the method further comprises aggregating nodes of the graph with a graph aggregation neural network to form a plurality of aggregated temporal representations.

17. The system of claim 15, wherein:
a first node of the graph is a first latent vector,
a second node of the graph is a second latent vector, and
an edge of the graph is a dependency relation between the first latent vector and the second latent vector.

18. The system of claim 16, wherein the method further comprises converting the aggregated temporal representations to reconstructed time-domain signals using a decoder neural network.

19. The system of claim 18, wherein the method further comprises determining whether the received time-domain signals are normal based on a measure of discrepancy between the received time-domain signals and the reconstructed time-domain signals.

20. A computer-readable medium storing instructions that, when executed by a processing circuit, cause the processing circuit to perform a method, the method comprising:
converting a plurality of received time-domain signals to a plurality of latent vectors with an encoder neural network;
converting the plurality of latent vectors to random vectors with a temporal neural network and sampling operation;
converting the plurality of latent vectors to a connectivity representation with a spatial neural network and sampling operation;
merging the latent vectors and the connectivity representation; and
transmitting a determination of whether the received time-domain signals are normal, based on the latent vectors and the connectivity representation.
